(19) United States
(12) Patent Application Publication
(10) Pub. No.: US 2013/0336094 A1
(43) Pub. Date: Dec. 19, 2013

(54) SYSTEMS AND METHODS FOR DETECTING DRIVER PHONE USE LEVERAGING CAR SPEAKERS

(71) Applicant: Rutgers, The State University of New Jersey, New Brunswick, NJ (US)

(72) Inventors: Marco Gruteser, Princeton, NJ (US); Richard Paul Martin, New Brunswick, NJ (US); Yingying Chen, Hoboken, NJ (US); Jie Yang, Hoboken, NJ (US)

(21) Appl. No.: 13/912,880

(22) Filed: Jun. 7, 2013

Related U.S. Application Data
(60) Provisional application No. 61/657,139, filed on Jun. 8, 2012.

(51) Int. Cl. G01S 11/14

(52) U.S. Cl. CPC G01S 11/14
USPC 367/117

(57) ABSTRACT

Systems and methods for determining a location of a device in a space in which speakers are disposed. The methods involve receiving a Combined Audio Signal (“CAS”) by an MCD microphone. The CAS is defined by a Discrete Audio Signal (“DAS”) output from the speakers. DAS may comprise at least one Sound Component (“SC”) having a frequency greater than frequencies within an audible frequency range for humans. The MCD analyzes CAS to detect an Arriving Time (“AT”) of SC of DAS output from a first speaker and an AT of SC of DAS output from a second speaker. The MCD then determines a first Relative Time Difference (“RTD”) between the DASs arriving from the first and second speakers based on the ATs which were previously detected. The first RTD is used to determine the location of the MCD within the space.

### CROSS REFERENCE TO RELATED APPLICATIONS

This application is a non-provisional application of U.S. Provisional Application Ser. No. 61/657,139 filed on Jun. 8, 2012, which is herein incorporated in its entirety.

### STATEMENT OF THE TECHNICAL FIELD

The inventive arrangements relate to systems and methods for acoustic relative-ranging for determining an approximate location of a mobile device in a confined area. More particularly, the inventive arrangements concern systems and methods leveraging an existing car audio infrastructure to determine on which car seat a phone is being used.

### DESCRIPTION OF THE RELATED ART

Distinguishing driver and passenger phone use is a building block for a variety of applications but its greatest promise arguably lies in helping reduce driver distraction. Cell phone distractions have been a factor in high-profile accidents and are associated with a large number of automobile accidents. For example, a National Highway Traffic Safety Administration (“NHTSA”) study identifies cell phone distraction as a factor in crashes that led to 995 fatalities and 24,000 injuries in 2009. This has led to increasing public attention and the banning of handheld phone use in several US states as well as many countries around the world.

Unfortunately, an increasing amount of research suggests that the safety benefits of handsfree phone operation are marginal at best. The cognitive load of conducting a cell phone conversation seems to increase accident risk, rather than the holding of a phone to the ear. Of course, texting, email, navigation, games and many other apps on smartphones are also increasingly competing with driver attention and pose additional dangers. This has led to a renewed search for technical approaches to the driver distraction problem. Such approaches run the gamut from improved driving mode user interfaces, which allow quicker access to navigation and other functions commonly used while driving, to apps that actively prevent phone calls. In between these extremes lie more subtle approaches: routing incoming calls to voicemail or delaying incoming text notifications.

All of these applications would benefit from and some of them depend on automated mechanisms for determining when a cell phone is used by a driver. Prior research and development has led to a number of techniques that can determine whether a cell phone is in a moving vehicle—for example, based on cell phone handoffs, cell phone signal strength analysis, or speed as measured by a Global Positioning System (“GPS”) receiver. The latter approach appears to be the most common among apps that block incoming or outgoing calls and texts. That is, the apps determine that the cell phone is in a vehicle and activate blocking policies once speed crosses a threshold. Some apps require the installation of specialized equipment in an automobile's steering column, which then allows blocking calls/text to/from a given phone based on car's speedometer readings, or even rely on a radio jammer. None of these solutions, however, can automatically distinguish a driver's cell phone from a passenger's.

While there does not exist any detailed statistics on driver versus passenger cell phone use in vehicles, a federal accident database reveals that about 38% of automobile trips include passengers. Not every passenger carries a phone—still this number suggests that the false positive rate when relying only on vehicle detection would be quite high. It would probably be unacceptably high even for simple interventions such as routing incoming calls to voicemail. Distinguishing drivers and passengers is challenging because car and phone usage patterns can differ substantially. Some might carry a phone in a pocket, while others place it on the vehicle console. Since many vehicles are driven mostly by the same driver, one promising approach might be to place a Bluetooth device into the vehicles, which allows the phone to recognize it through the Bluetooth identifier. Still, this cannot cover cases where one person uses the same vehicle as both driver and passenger, as is frequently the case for family cars. Also, some vehicle occupants might pass their phone to others, to allow them to try out a game, for example.

### SUMMARY OF THE INVENTION

The present invention concerns systems and methods for determining a location of a device (e.g., a Mobile Communication Device (“MCD”)) in a space (e.g., a confined space of the interior of a vehicle) in which a plurality of external speakers are disposed. The methods involve: optionally communicating the discrete audio signal from the MCD to an external audio unit disposed within the space via a short range communication (e.g., a Bluetooth communication); and causing the discrete audio signal to be output from the external speakers. In some scenarios, the discrete audio signal is sequentially output from the external speakers in the pre-assigned order. Subsequently, the combined audio signal is received by a single microphone of the MCD. The combined audio signal is defined by the discrete audio signal which was output from the external speakers. The discrete audio signal may comprise at least one sound component (e.g., a beep) having a frequency greater than frequencies within an audible frequency range for humans. Thereafter, the MCD analyzes the combined audio signal to detect an arriving time of the sound component of the discrete audio signal output from a first speaker (e.g., a left speaker or a right speaker) and an arriving time of the sound component of the discrete audio signal output from a second speaker (e.g., a left speaker or a right speaker). A first relative time difference is then determined between the discrete audio signals arriving from the first and second speakers based on the arriving times which were previously detected. The location of the MCD within the confined space is determined based on the first relative time difference.

In some scenarios, the first relative time difference is computed using a first number of samples and a sampling frequency. The first number of samples comprises the number of samples between the sound component of the discrete audio signal output from the first speaker (e.g., a front-left speaker) and the sound component of the discrete audio signal output from the second speaker (e.g., a front-right speaker). A first physical distance is then computed between the MCD and two first speakers (i.e., the first and second speakers) using the first relative time difference and speed of sound. Next, the first physical distance is compared to a threshold value. The location of the MCD can be determined based on results of the comparing. For example, the results of the comparing may indicate that the MCD is located within a driver-side portion of the confined space of a vehicle's interior or a passenger-side portion of the confined space of the vehicle's interior. In this case, the MCD may subsequently perform one or more operations to reduce distractions of a driver of the vehicle based on its determined location within the confined space of the vehicle's interior.

In some scenarios, the first relative time difference is computed using the discrete audio signal output from the first speaker (e.g., a front-left speaker) and the sound component of the discrete audio signal output from the second speaker (e.g., a rear-left speaker). Also, a second relative time difference is determined between the discrete audio signals arriving from third and fourth speakers (e.g., the front-right speaker and the rear-right speaker) using a second number of samples and the sampling frequency. The second number of samples comprises the number of samples between the sound component of the discrete audio signal output from the third speaker and the sound component of the discrete audio signal output from the fourth speaker. A second physical distance is then determined between the MCD and two second speakers (i.e., the third and fourth speakers) using the second relative time difference and the speed of sound. An average of the first and second physical distances is then compared to a threshold value. The location of the MCD can then be determined based on results of the comparing. For example, the results of the comparing may indicate that the MCD is located within a front portion of the confined space of a vehicle's interior or a rear portion of the confined space of the vehicle's interior. In this case, the MCD may perform one or more operations to reduce distractions of a driver of the vehicle based on its determined location within the confined space of the vehicle's interior.

### BRIEF DESCRIPTION OF THE DRAWINGS

Embodiments will be described with reference to the following drawing figures, in which like numerals represent like items throughout the figures, and in which:

FIG. 1 is a schematic illustration of an exemplary system that is useful for understanding the present invention.

FIG. 2 is a schematic illustration of an exemplary architecture for the Mobile Communication Device (“MCD”) shown in FIG. 1.

FIG. 3 is a flow diagram of an exemplary acoustic relative-ranging method for determining on which an approximate location of an MCD within a confined space.

FIG. 4 is a schematic illustration that is useful for understanding acoustic relative ranging when applied to a speaker pair i and j (e.g., the front-left and front-right speakers of a vehicle).

FIG. 5 comprises two graphs illustrating a frequency sensitivity comparison between a human ear and a smartphone that is useful for understanding the present invention.

FIGS. 6A-6B collectively provide a flow diagram of an exemplary method for determining which speaker of a plurality of speakers is closest to an MCD.

FIG. 7 comprises two graphs illustrating how a first arrival signal is detected in accordance with the present invention.

FIG. 8 is a schematic illustration of exemplary positions of an MCD in a vehicle.

FIG. 9 is a graph showing an accuracy of detecting driver phone use for different positions in a car setting under calibrated thresholds.

FIG. 10 comprises two graphs illustrating boxplots of a measured Δdₗᵣ at different tested positions.

FIG. 11 is a graph plotting a standard deviation of relative ranging results at different positions.

FIG. 12 shows a Receiver Operating Curve (“ROC”) of detecting a phone at front seats for a particular scenario.

FIG. 13 shows a histogram of measurement error in a vehicle for both the present method and a correlation method with multipath mitigation mechanism.

FIG. 14 is a graph that is useful for analyzing an impact of background noise.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects as illustrative. The scope of the invention is, therefore, indicated by the appended claims. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

Introduction

The present invention generally concerns an Acoustic Relative-Ranging System (“ARRS”) that leverages an existing audio infrastructure of a vehicle, building or room to determine an approximate location of an MCD within a confined space thereof. In some scenarios, the ARRS is used to determine on which car seat an MCD is being used. Accordingly, the ARRS may rely on the assumptions that: (i) the car seat location is one of the most useful decimators for distinguishing driver and passenger cell phone use; and (ii) most cars will allow phone access to the car audio infrastructure. Indeed, an industry report discloses that more than 8 million built-in Bluetooth systems were sold in 2010 and predicts that 90% of new cars will be equipped in 2016. Therefore, in the car scenario, ARRS may leverage this Bluetooth access to the audio infrastructure to avoid the need to deploy additional infrastructure in cars. In all scenarios, the classifier's strategy first uses high frequency sound components (e.g., beeps) sent from an MCD (e.g., a Smartphone) over a short range communication connection (e.g., a Bluetooth connection) through the vehicles, building or room's stereo system. The sound components (e.g., beeps) are recorded by the MCD, and then analyzed to deduce the timing differentials between the left and right speakers (and if possible, front and rear ones). From the timing differentials, the MCD can self-determine which side or quadrant of the vehicle, building or room it is in.

While acoustic localization and ranging have been extensively studied for human speaker localization through microphone arrays, the present invention addresses several unique challenges in the ARRS. First, the ARRS uses only a single microphone and multiple speakers, requiring a solution that minimizes interference between the speakers. Second, the small confined space inside a vehicle, building or room presents a particularly challenging multipath environment. Third, any sounds emitted should be unobtrusive to minimize distraction. Salient features of the present solution that address these challenges are:
By exploiting the relatively controlled, symmetric positioning of speakers inside the vehicle, building or room, the ARRS can perform seat classification even without the need for calibration, fingerprinting or additional infrastructure.
To make the present approach unobtrusive, the AARS uses very high frequency discrete signals (e.g., signals of beeps with a frequency of about 18 kHz). Both the number and length of the sound components (e.g., beeps) are relatively short. This exploits that today's MCD microphones and speakers have a wider frequency response than most peoples' auditory system.
To address significant multipath and noise in the confined space environment, the AARS employs several signal processing steps including bandpass filtering to remove low-frequency noise. Since the first arriving signal is least likely to stem from multipath, a sequential change-point detection technique is employed that can quickly identify the start of the first signal.

By relaxing the problem from full localization to classification of whether the MCD is in a particular area (e.g., a driver or passenger seat area) of a confined space, a first generation system may be enabled through a software application (e.g., a smart-phone application) that is practical today in all cases with built-in short range communication technology (e.g., Bluetooth technology). This is because left-right classification can be achieved with only stereo audio.

Discussion of Exemplary AARS

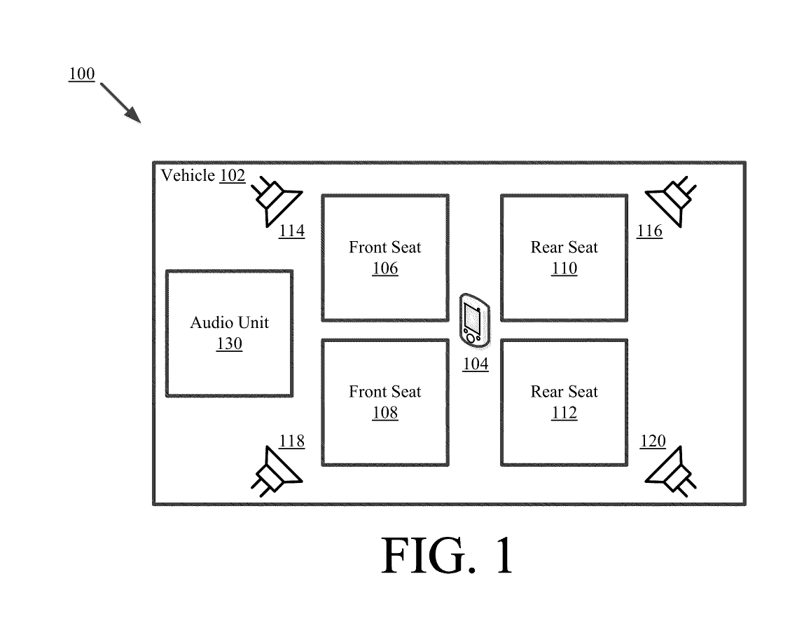

Embodiments will now be described with respect to FIGS. 1-7. Embodiments of the present invention will be described herein in relation to vehicle applications. The present invention is not limited in this regard, and thus can be employed in various other types of applications in which a location of an MCD within a confined space needs to be determined (e.g., business meeting applications and military applications).

In the vehicle context, embodiments generally relate to ARRSs and methods employing an Acoustic Relative-Ranging (“ARR”) approach for determining which car seat an MCD is being used. Notably, the present systems and methods do not require the addition of dedicated infrastructure to the vehicle. In many vehicles (e.g., cars), the speaker system is already accessible over Short Range Communication (“SRC”) connections (e.g., Bluetooth connections) and such systems can be expected to trickle down to most new vehicles (e.g., cars) over the next few years. This allows software solutions and/or hardware solutions. The ARR approach leads to the following additional challenges: unobtrusiveness; robustness to noise and multipath; and computational feasibility on MCDs (e.g., Smartphones). With regard to the unobtrusiveness challenge, the sounds emitted by the audio system should not be perceptible to the human ear, so that it does not annoy or distract the vehicle occupant. With regard, to the robustness challenge, engine noise, tire and road noise, wind noise, and music or conversations all contribute to a relatively noisy in-vehicle environment. A vehicle is also a relatively small confined space creating a challenging heavy multipath scenario. With regard to the computation feasibility challenge, standard MCD (e.g., Smartphone) platforms should be able to execute signal processing and detection algorithms with sub-second runtimes. The manner in which each of these challenges is addressed by the present invention will become evident as the discussion progresses.

Referring now to FIG. 1, there is provided a schematic illustration of an exemplary system 100 that is useful for understanding the present invention. System 100 employs an ARR approach for determining which seat 106, 108, 110, 112 of a vehicle 102 an MCD 104 is being used. The vehicle 102 can include, but is not limited to, a car, truck, van, bus, tractor, boat or plane. The MCD 104 can include, but is not limited to, a mobile phone, a Personal Digital Assistant (“PDA”), a portable computer, a portable game station, a portable telephone and/or a mobile phone with smart device functionality (e.g., a Smartphone).

As shown in FIG. 1, the vehicle 102 comprises an audio unit 130 and a plurality of speakers 114, 116, 118, 120. Audio units and speakers are well known in the art, and therefore will not be described in detail herein. Still, it should be understood that any known audio unit and/or multi-speaker system can be used with the present invention without limitation.

During operation of system 100, components 114, 116, 118, 120, 130 are used in conjunction with the MCD 104 to perform ARR. ARR operations can be triggered in various ways. For example, ARR operations can be triggered in response to: the reception of an incoming communication (e.g., a call, a text message or an email) at the MCD 104; a registration of the MCD 104 with the audio unit 130 via a Short Range Communication (“SRC”); the detection of movement of the MCD 104 (e.g., through the use of an accelerometer thereof) and/or vehicle 102; the detection that the MCD 104 is in proximity of the vehicle 102; the detection of a discrete audio signal transmitted from another MCD in proximity to MCD 104 or the audio unit 130 of the vehicle 102; and/or the auto-pairing of the MCD with the SRC equipment of the vehicle. The SRC can include, but is not limited to, a Near Field Communication (“NFC”), InfRared (“IR”) technology, Wireless Fidelity (“Wi-Fi”) technology, Radio Frequency Identification (“RFID”) technology, Bluetooth technology, and/or ZigBee technology.

When the ARR operations are triggered, the MCD 104 generates and transmits an audio signal to the speakers 114, 116, 118, 120 of the vehicle via an SRC (e.g., a Bluetooth communication). In some scenarios, the audio signal is inserted into a music stream being output from the MCD. The audio signal is then output through the speakers 114, 116, 118, 120. The MCD 104 records the sound emitted from the speakers 114, 116, 118, 120. The recorded sound is then processed by the MCD 104 to evaluate propagation delay. Rather than measuring absolute delay (which is affected by unknown processing delays on the MCD 104 and in the audio unit 130), the system 100 measures relative delay between the audio signal output from the left and right speaker(s). This is similar in spirit to time-difference-of-arrival localization and does not require clock synchronization.

In vehicle 102, the speakers 114, 116, 118, 120 are placed so that the plane equidistant to the left and right (front) speaker locations separates the driver-side and passenger-side area. This has two benefits. First, for front seats 106, 108 (the most frequently occupied seats), the system 100 can distinguish the driver seat and the passenger seat by measuring only the relative time difference between the front speakers 114, 118. Second, the system 100 does not require any fingerprinting or calibration since a time difference of zero always indicates that the MCD 104 is located between driver and passenger (on the center console).

The two-channel approach is practical with current hands-free and SRC (e.g., Bluetooth) profiles which provide for stereo audio. The concept can be easily extended to a four-channel approach, which promises better accuracy but requires updated surround sound audio units and SRC profiles of the vehicle 102. The two-channel approach and the four-channel approach will both be described herein.

System 100 differs from typical acoustic human speaker localization, in that a single microphone and multiple sound sources are used for ARR, rather than a microphone array to detect a single sound source. This means that time differences only need to be measured between signals arriving at the same microphone. This time difference can be estimated simply by counting the number of audio samples between the start of two audio signals. Most modern MCDS (e.g., Smartphones) offer an audio sampling frequency of 44.1 kHz, which given the speed of sound theoretically provides an accuracy of about 0.8 cm—the resolution under ideal situation, since the audio signal will be distorted.

The ARR technique of the present invention employs a Time-Division Multiplexing (“TDM”) approach for addressing signal interference and multi-signal differentiation. The TDM approach involves emitting sound from the speakers 114, 116, 118, 120 at different points in time, with a sufficiently large gap such that no interference occurs therebetween. The sound is emitted from the speakers 114, 116, 118, 120 in a pre-assigned order. The pre-assigned order may be pre-stored in the audio unit 130 and/or MCD 104. Additionally or alternatively, the pre-assigned order may be dynamically generated during each iteration of the ARR operations based on one or more parameters by the audio unit 130 and/or MCD 104. The parameters can include, but are not limited to, the manufacturer of the vehicle 102, the model of the vehicle 102, the production year of the vehicle 102, and/or the type of audio unit 130 installed in the vehicle 102.

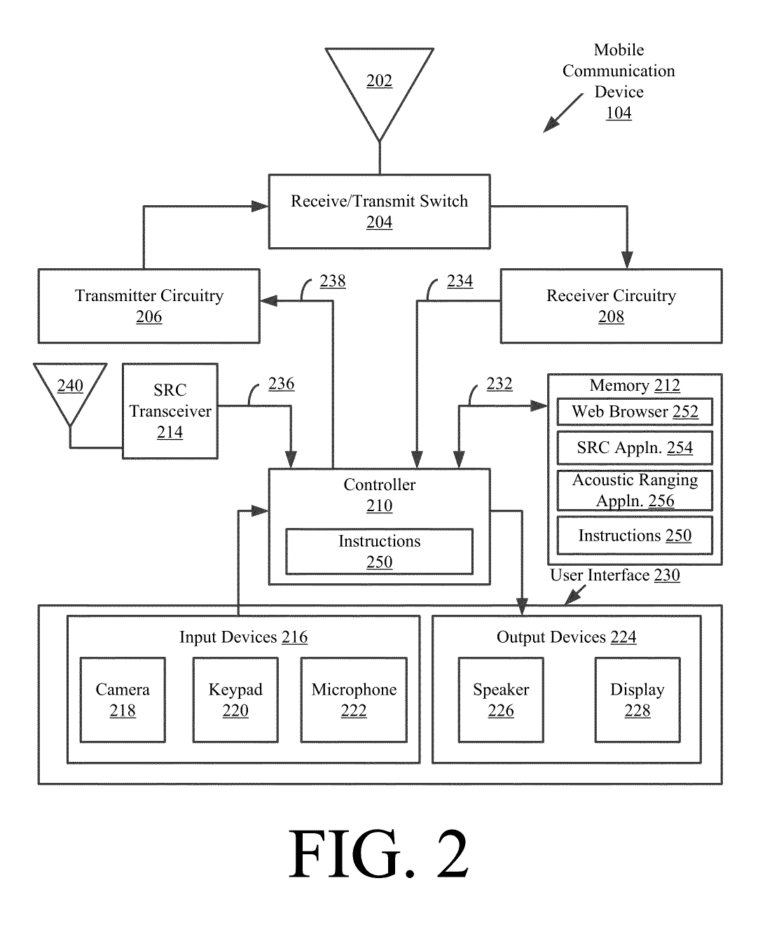

Referring now to FIG. 2, there is provided a block diagram of an exemplary architecture for the MCD 104. As noted above, MCD 104 can include, but is not limited to, a notebook computer, a personal digital assistant, a cellular phone, or a mobile phone with smart device functionality (e.g., a Smartphone). MCD 104 may include more or less components than those shown in FIG. 2. However, the components shown are sufficient to disclose an illustrative embodiment implementing the present invention. Some or all of the components of the MCD 104 can be implemented in hardware, software and/or a combination of hardware and software. The hardware includes, but is not limited to, one or more electronic circuits.

The hardware architecture of FIG. 2 represents one embodiment of a representative MCD 104 configured to facilitate a determination as to which seat 106, 108, 110, 112 of the vehicle 102 an MCD 104 is being used. In this regard, MCD 104 comprises an antenna 202 for receiving and transmitting RF signals. A receive/transmit (“Rx/Tx”) switch 204 selectively couples the antenna 202 to the transmitter circuitry 206 and receiver circuitry 208 in a manner familiar to those skilled in the art. The receiver circuitry 208 demodulates and decodes the RF signals received from a network (not shown). The receiver circuitry 208 is coupled to a controller (or microprocessor) 210 via an electrical connection 234. The receiver circuitry 208 provides the decoded signal information to the controller 210. The controller 210 uses the decoded RF signal information in accordance with the function(s) of the MCD 104.

The controller 210 also provides information to the transmitter circuitry 206 for encoding and modulating information into RF signals. Accordingly, the controller 210 is coupled to the transmitter circuitry 206 via an electrical connection 238. The transmitter circuitry 206 communicates the RF signals to the antenna 202 for transmission to an external device (e.g., a node of a network) via the Rx/Tx switch 204.

An antenna 240 may be coupled to an SRC transceiver 214 for transmitting and receiving SRC signals (e.g., Bluetooth signals). The SRC transceiver 214 may include, but is not limited to, an NFC transceiver or a Bluetooth transceiver. NFC transceivers and Bluetooth transceivers are well known in the art, and therefore will not be described in detail herein. However, it should be understood that the SRC transceiver 214 transmits audio signals to an external audio unit (e.g., audio unit 130 of FIG. 1) in accordance with an SRC application 254 and/or an acoustic ranging application 256 installed on the MCD 104. The SRC transceiver 214 also processes received SRC signals to extract information therefrom. The SRC transceiver 214 may process the SRC signals in a manner defined by the SRC application 254 installed on the MCD 104. The SRC application 254 can include, but is not limited to, a Commercial Off The Shelf (“COTS”) application. The SRC transceiver 214 provides the extracted information to the controller 210. As such, the SRC transceiver 214 is coupled to the controller 210 via an electrical connection 236. The controller 210 uses the extracted information in accordance with the function(s) of the MCD 104. For example, the extracted information can be used by the MCD 104 to register with an audio unit (e.g., audio unit 130 of FIG. 1) of a vehicle (e.g., vehicle 102 of FIG. 1).

The controller 210 may store received and extracted information in memory 212 of the MCD 104. Accordingly, the memory 212 is connected to and accessible by the controller 210 through electrical connection 232. The memory 212 may be a volatile memory and/or a non-volatile memory. For example, the memory 212 can include, but is not limited, a RAM, a DRAM, an SRAM, a ROM and a flash memory. The memory 212 may also comprise unsecure memory and/or secure memory. The memory 212 can be used to store various other types of information therein, such as authentication information, cryptographic information, location information and various service-related information.

As shown in FIG. 2, one or more sets of instructions 250 are stored in memory 212. The instructions 250 may include customizable instructions and non-customizable instructions. The instructions 250 can also reside, completely or at least partially, within the controller 210 during execution thereof by MCD 104. In this regard, the memory 212 and the controller 210 can constitute machine-readable media. The term “machine-readable media”, as used here, refers to a single medium or multiple media that stores one or more sets of instructions 250. The term “machine-readable media”, as used here, also refers to any medium that is capable of storing, encoding or carrying the set of instructions 250 for execution by the MCD 104 and that causes the MCD 104 to perform one or more of the methodologies of the present disclosure.

The controller 210 is also connected to a user interface 230. The user interface 230 comprises input devices 216, output devices 224 and software routines (not shown in FIG. 2) configured to allow a user to interact with and control software applications (e.g., application software 252-256 and other software applications) installed on the MCD 104. Such input and output devices may include, but are not limited to, a display 228, a speaker 226, a keypad 220, a directional pad (not shown in FIG. 2), a directional knob (not shown in FIG. 2), a microphone 222 and a camera 218. The display 228 may be designed to accept touch screen inputs. As such, user interface 230 can facilitate a user-software interaction for launching applications (e.g., application software 252-256) installed on MCD 104. The user interface 230 can facilitate a user-software interactive session for writing data to and reading data from memory 212.

The display 328, keypad 320, directional pad (not shown in FIG. 2) and directional knob (not shown in FIG. 2) can collectively provide a user with a means to initiate one or more software applications or functions of the MCD 104. The application software 254-256 can facilitate ARR operations for a determination as to an approximate location of the MCD 104 within a confined space. More particularly, to facilitate a determination as to which seat (e.g., seat 106, 108, 110, 112) of the vehicle (e.g., vehicle 102 of FIG. 1) the MCD 104 is being used. In this regard, at least the acoustic ranging application 256 is configured to implement some or all of the ARR operations of the present invention.

The ARR operations can include performing a calibration process to select values of certain parameters (e.g., threshold values) based on the manufacturer of the vehicle 102, the model of the vehicle 102, the production year of the vehicle 102, and/or the type of audio unit 130 installed in the vehicle 102. The ARR operations can also include selecting a two channel ARR technique or a four channel ARR technique for subsequent use in determining the approximate location of the MCD 104 within a confined space. The type of ARR technique can be selected based on the manufacturer of the vehicle 102, the model of the vehicle 102, the production year of the vehicle 102, and/or the type of audio unit 130 installed in the vehicle 102.

The ARR operations can further involve: determining whether or not a vehicle is moving; receiving an incoming communication (e.g., a call, a text message, or an email); generating an audio signal in response to the reception of the incoming communication; causing an external audio unit to generate the audio signal; cause the audio signal to be transmitted from the MCD 104 to an external audio unit (e.g., audio unit 130 of FIG. 1) via an SRC (e.g., a Bluetooth communication); optionally dynamically selecting an order in which the audio signal is to be output from a plurality of speakers (e.g., speakers 114-120 of FIG. 1); causing the audio signal to be output from external speakers in a pre-assigned order; record received audio signals; processing the recorded audio signals to evaluate propagation delay between the audio signals emitted from left speakers (e.g., speakers 118 and 120 of FIG. 1) and right speakers (e.g., speakers 114 and 116 of FIG. 1); processing the recorded audio signals to evaluate propagation delay between the audio signals emitted from two left speakers (e.g., speakers 118 and 120 of FIG. 1) or two right speakers (e.g., speakers 114 and 116 of FIG. 1); and causing select operations to be performed by the MCD based on which speaker was determined to be closest to the MCD. For example, the MCD can be caused to perform various safety operations to reduce distractions to a driver of a vehicle (e.g. vehicle 102 of FIG. 1) when the left-front speaker (or driver-side speaker) is determined to be closest thereto.

Such safety operations can include, but are not limited to: automatically displaying less distracting driver user interfaces; outputting an indicator only for calls and/or text messages received from certain people; directing incoming calls to voicemail when they are being received from select external devices and/or people; causing a driving status to be displayed in friends dialer applications to discourage them from calling; and/or the MCD could be locked to prevent out going communications. The safety operations can also involve integrating with vehicle controls. Perhaps a driver chatting on the phone should increase the responsiveness of a vehicle's braking system, since this driver is more likely to brake late. The level of intrusiveness of lane-departure warning and driver asset systems could also be affected as a result of the safety operations.

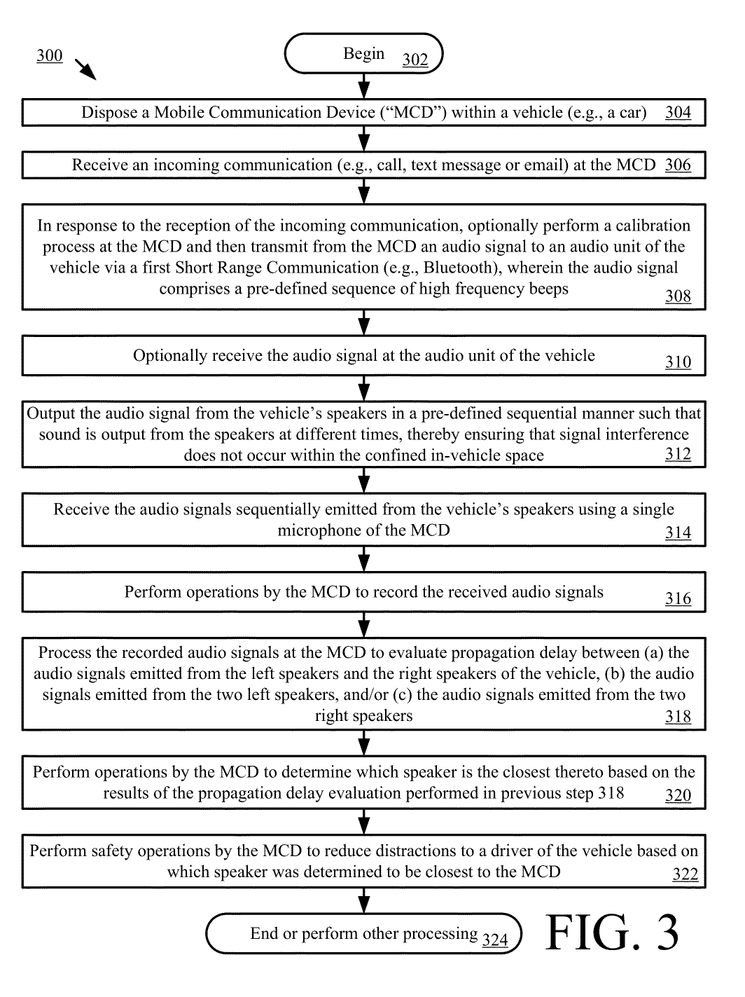

Referring now to FIG. 3, there is provided a flow diagram of an exemplary ARR method 300 for determining an approximate location of an MCD (e.g., MCD 104 of FIGS. 1-2) within a confined space, such as an interior space of a vehicle (e.g., vehicle 102 of FIG. 1). Method 300 begins with step 302 and continues with step 304. In step 304, an MCD is disposed within a vehicle (e.g., vehicle 102 of FIG. 1). Next in step 306, an event occurs for triggering ARR operations. For example, an incoming communication (e.g., a call, text message or email) can be received by the MCD which causes the ARR operations to be triggered. Additionally or alternatively, step 306 can involve: registering the MCD with the audio unit 130 via an SRC (e.g., a Bluetooth communication); detecting movement of the MCD (e.g., through the use of an accelerometer thereof); and/or detecting that the MCD is in proximity of the vehicle.

After triggering the ARR operations, optional steps 308 and 310 may be performed. Step 308 involves optionally performing a calibration process to select values for certain parameters, such as threshold values for two-channel and/or four-channel ARR processes to determine an approximate location of the MCD within a confined space of the vehicle. The parameters values can be selected based on the manufacturer of the vehicle 102, the model of the vehicle 102, the production year of the vehicle 102, and/or the type of audio unit 130 installed in the vehicle 102. The optional calibration process may not be performed by the MCD in step 308 when the calibration process was previously performed, such as at the factory.

Step 308 also involves transmitting an audio signal from the MCD to an audio unit (e.g., audio unit 130 of FIG. 1) of the vehicle via an SRC (e.g., a Bluetooth communication). The audio signal can include, but is not limited to, a discrete audio signal. In some scenarios, the discrete audio signal includes a pre-defined sequence of high frequency sound components (e.g., beeps). Step 310 involves receiving the audio signal at the audio unit of the vehicle. Notably, optional steps 308-310 may not be performed when the audio signal is generated by the audio unit of the vehicle. In this scenario, steps 308-310 can alternatively involve: transmitting a command from the MCD to the audio unit for generating an audio signal; and generating the audio signal at the audio unit.

Next, step 312 is performed where the audio signal is output from the vehicle's speaker (e.g., speakers 114-120 of FIG. 1). The audio signal is output from the speakers in a pre-defined sequential manner such that the sound is output from the speakers at different times, thereby ensuring that signal interference does not occur within the confined space of the vehicle. In some scenarios, the audio signal is spread over a range of high frequency prior to being transmitted from the speakers. This signal spreading may be employed to improve accuracy of the ARR technique.

Subsequent to completing step 312, the audio signals are received by the microphone (e.g., microphone 222 of FIG. 2), as shown by step 314. In step 316, the MCD performs operations to record the received audio signals. The recorded audio signals are then processed by MCD in step 318 to evaluate one or more propagation delays. For example, step 318 involves evaluating the propagation delay between: (a) the audio signals emitted from the left speakers (e.g., speakers 118 and 120 of FIG. 1) and the right speakers (e.g., speakers 114 and 116 of FIG. 1) of the vehicles; (b) the audio signals emitted from the two left speakers; and/or (c) the audio signals emitted from the two right speakers.

A decision is then made in step 320 to determine which speaker is closest to the MCD based on the results of the propagation delay evaluation of step 318. Once the closest speaker is identified, step 322 is performed where one or more select operations are performed by the MCD, such as safety operations to reduce distraction to a driver of the vehicle. The safety operations can include, but are not limited to, re-directing an incoming communication to a mailbox or voice mail without outputting an auditory or tactile indicator indicating that an incoming communication is being received by the MCD. Thereafter, step 324 is performed where method 300 ends or other processing is performed.

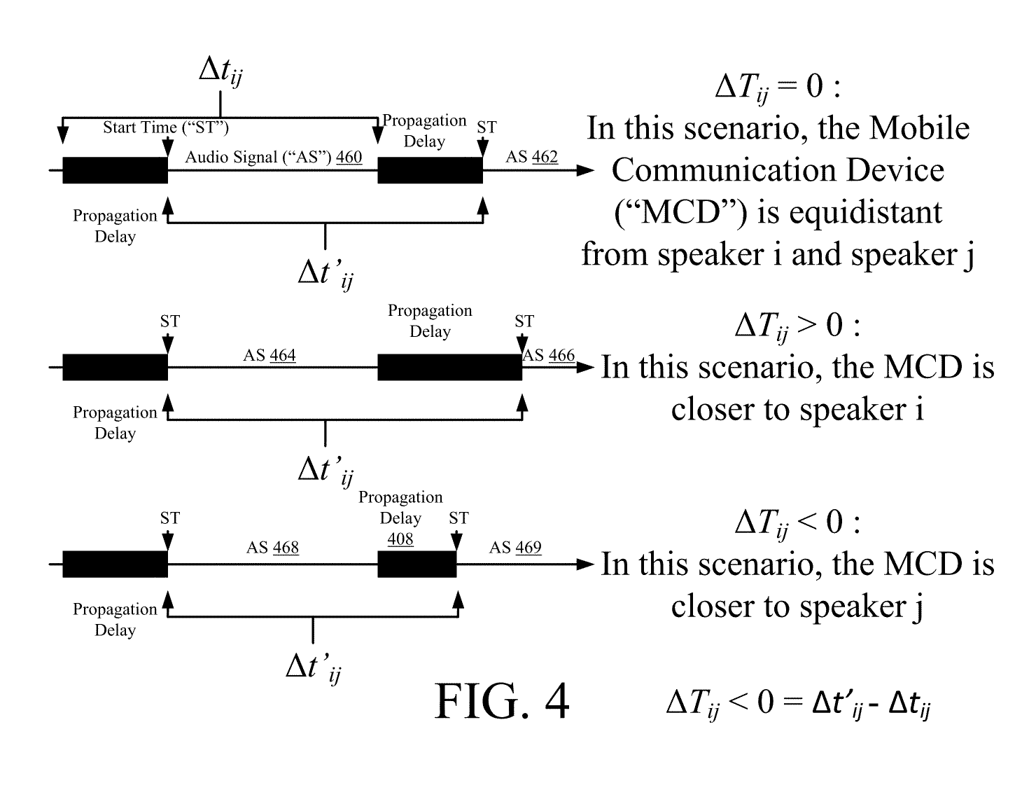

Referring now to FIG. 4, there is provided a schematic illustration that is useful for understanding ARR when applied to a speaker pair i and j (e.g., the front-left and front-right speakers of a vehicle). Assume the fixed time interval between two emitted sounds 460/462, 464/466, 468/469 by a speaker pair i and j is Δtᵢⱼ. Let Δt′ᵢⱼ be the time difference when a microphone (e.g., microphone 222 of FIG. 2) records these sounds. The time difference of the sounds received by the MCD from the two speakers i and j is defined by the following mathematical equation (1)

Δ(Tᵢⱼ)=Δt′ᵢⱼ−Δtᵢⱼ;i≠j i,j=1,2,3,4 (1)

When the microphone is equidistant from the two speakers i and j, Δ(Tᵢⱼ)=0. If Δ(Tᵢⱼ)<0, then the MCD (e.g., MCD 104) is closer to speaker i. If Δ(Tᵢⱼ)>0, then the MCD (e.g., MCD 104) is closer to speaker j.

In the present system 100, the absolute time the sounds emitted by the speakers (e.g., speakers 114 and 118 of FIG. 1) are unknown to the MCD 104, but the MCD 104 does know the time difference Δtᵢⱼ. Similarly, the absolute times the MCD records the sounds might be affected by MCD processing delays, but the difference Δt′ᵢⱼ can be easily calculated using the sample counting. As can be seen, from the equations above, these two differences are sufficient to determine which speaker is closer.

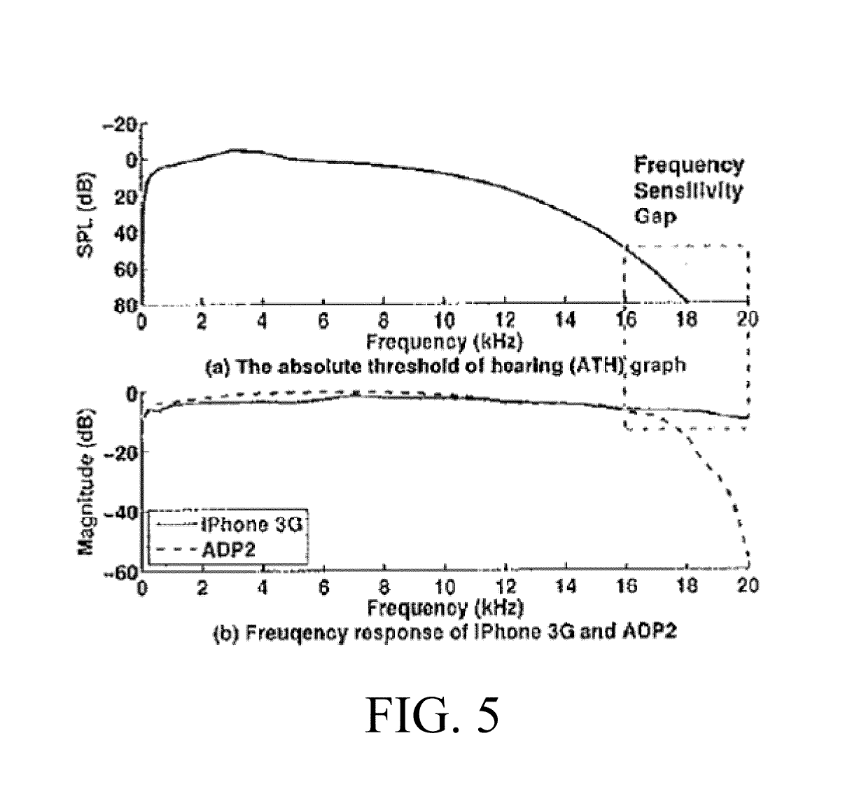

An exemplary discrete audio signal design will now be described in relation to FIG. 5. As noted above, a high frequency sound component (e.g., a beep) may be used in the ARR operations. The high frequency sound component (e.g., a beep) may be selected to reside at the edge of an MCD microphone frequency response curve, since this makes it easier to filter out noise and renders the audio signal imperceptible to most people. The majority of the typical vehicle noise sources are in lower frequency bands. For example, the noise from the engine, tire/road, and wind are mainly located in the low frequency bands below 1 kHz, whereas conversation ranges from approximately 300 Hz to 3400 Hz. Music has a wide range, the FM radio for example spans a frequency range from 50 Hz to 15,000 Hz, which covers almost all naturally occurring sounds. Although separating noise can be difficult in the time domain, noise separation in the present invention is performed in the frequency domain by locating the audio signal above 15 kHz.

Such high frequency sounds are also hard to perceive by the human auditory system. Although the frequency range of human hearing is generally considered to be 20 Hz to 20 kHz, high frequency sounds must be much louder to be noticeable. This is characterized by the Absolute Threshold of Hearing (“ATH”), which refers to the minimum sound pressure that can be perceived in a quiet environment. FIG. 5(a) shows how the ATH varies over frequency. Note, how the ATH increases sharply from frequencies over 10 kHz and how human hearing becomes extremely insensitive to frequencies beyond 18 kHz. For example, human ears can detect sounds as low as 0 dB Sound Pressure Level (“SPL”) at 1 kHz, but require about 80 dB SPL beyond 18 kHz—a 10,000 fold amplitude increase.

Fortunately, the MCD microphone (e.g., microphone 222 of FIG. 2) is more sensitive to the high frequency range. FIG. 5(b) plots the corresponding frequency response curves for an iPhone 3G and an Android Developer Phone 2 (“ADP2”). Although the frequency response also falls off in the high frequency band, it is still able to pick up sounds in a wider range than most human ears. Therefore, in some scenarios, frequencies in this range are selected for use in ARR operations. For example, 16-18 kHz range was selected for the ADP2 phone and the 18-20 kHz range was selected for the iPhone 3G. Embodiments of the present invention are not limited in this regard.

The length of the sound components (e.g., beeps) impacts the overall detection time as well as the reliability of recording the sound components (e.g., beeps). Too short a sound component (e.g., a beep) is not picked up by the MCD microphone (e.g., microphone 222 of FIG. 2). Too long a sound component (e.g., a beep), will add delay to the system and will be more susceptible to multi-path distortions. Thus, in some scenarios, a sound component (e.g., beep) length of 400 samples (i.e., 10 ms) was used because it provides a good tradeoff between the drawbacks of short and long sound components (e.g., beeps).

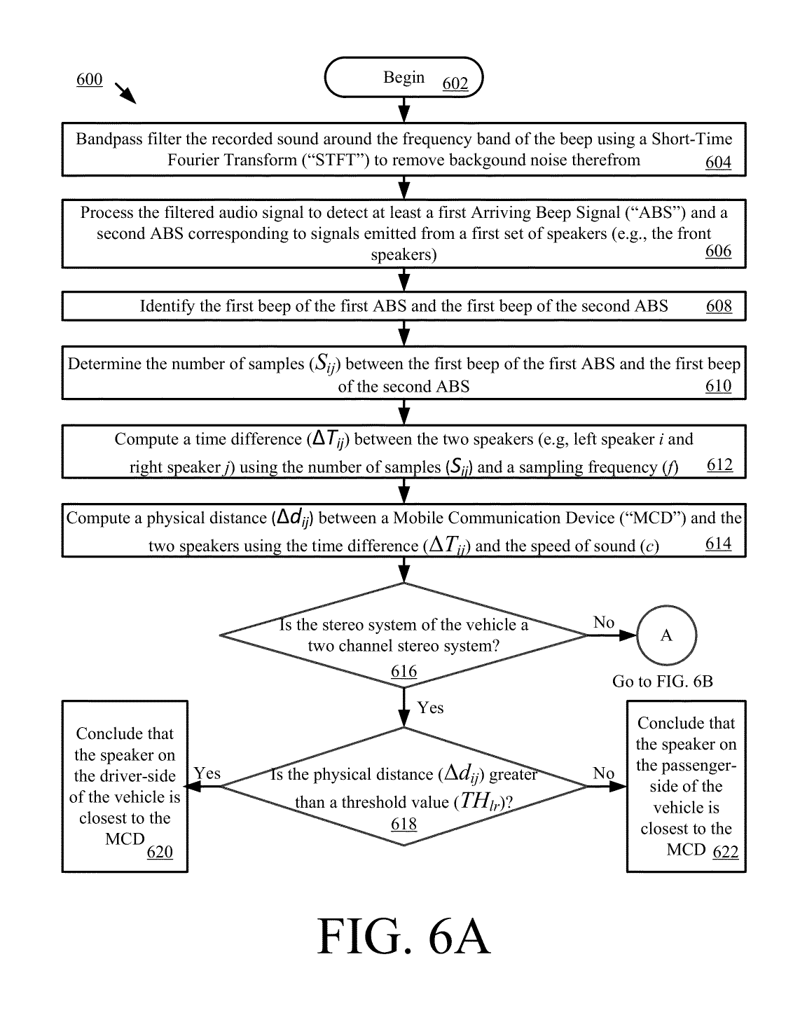

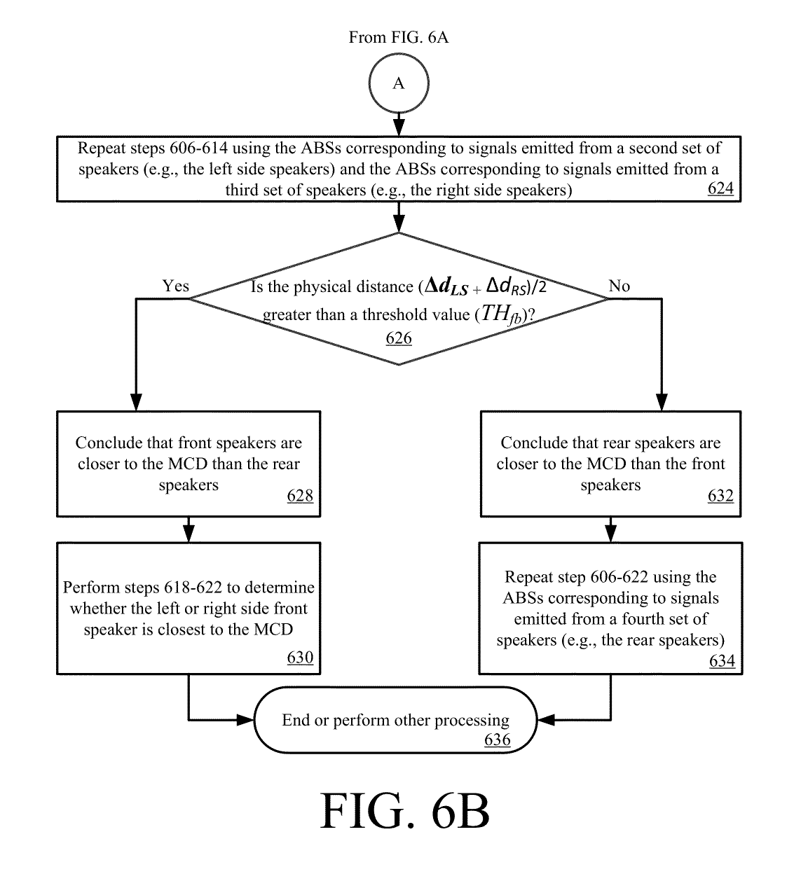

Referring now to FIGS. 6A-6B there is provided a flow diagram of an exemplary method 600 for determining which speaker of a plurality of speakers is closest to an MCD (e.g., MCD 104 of FIGS. 1-2). Notably, method 600 comprises the performance of four sub-tasks (i.e., filtering, signal detection, relative ranging, and location classification) to determine an approximate location of the MCD within a confined space (e.g., the interior of a vehicle 100 of FIG. 1). As such, method 600 can be implemented in steps 318-320 of FIG. 3.

As shown in FIG. 6A, method 600 begins with step 602 and continues with step 604. In step 604, the recorded sound is processed to bandpass filter the same around the frequency of the sound component (e.g., the beep). The bandpass filtering can be achieved using a Short-Time Fourier Transform (“STFT”) to remove background noise from the recorded sound. STFT algorithms are well known in the art, and therefore will not be described herein. The output of the bandpass filter is referred to below as a “filtered audio signal”.

Next in step 606, the filtered audio signal is processed to detect at least a first Arriving Beep Signal (“ABS”) and a second ABS corresponding to signals emitted from a first set of speakers (e.g., the front speakers). Thereafter in step 608, a first sound component (e.g., a first beep) of the first ABS and the first sound component (e.g., a first beep) of the second ABS are identified, and their start times are noted.

Detecting the arrival of an ABS under heavy multipath in-car environments is challenging because the sound components (e.g., beeps) can be distorted due to interference from the multi-path components. In particular, the commonly used correlation technique, which detects the point of maximum correlation between a received signal and a known transmitted signal, is susceptible to such distortion. Furthermore, the use of high frequency sound components (e.g., beeps) can lead to distortions due to the reduced microphone sensitivity in this range.

For these reasons, a novel approach is used with the present invention is some scenarios. The novel approach involves detecting the first strong ABS in a specified frequency band. The signal detection is possible since there is relatively little noise and interference from outside sources in the chosen frequency range (e.g., a 16-18 kHz range or an 18-20 kHz range). This is known as sequential change-point detection in signal processing. The basic idea is to identify the first ABS that deviates from the noise after filtering out background noise. Let {X₁, . . . , Xₙ} be a sequence of recorded audio signal by the MCD over n time points. Initially, without the sound component (e.g., beep), the observed signal comes from noise, which follows a distribution with density function p₀. Later on, at an unknown time [symbol] , the distribution changes to density function p₁ due to the transmission of an audio (e.g., beep) signal. The objective is to identify this time [symbol] , and to declare the presence of a sound component (e.g., a beep) as quickly as possible to maintain the shortest possible detection delay, which corresponds to ranging accuracy.

To identify time [symbol] , the problem is formulated as sequential change-point detection. In particular, at each time point [symbol] , a determination is made as to whether or not an audio (e.g., a beep) signal is present and, if so, when the audio (e.g., beep) signal is present. Since the algorithm runs online, the sound component (e.g., beep) may not yet have occurred. Thus based on the observed sequence up to time point t {X₁, . . . , Xₙ}, the following two hypotheses are distinguished and time point [symbol] is identified.

H₀: Xᵢ follows p₀, i=1, . . . , t
H₁: Xᵢ follows p₀, i=1, . . . , [symbol] −1

Xᵢ follows p₁, i= [symbol] , . . . , t

If Hₒ is true, the algorithm repeats once more data samples are available. If the observed signal sequence {X₁, . . . , Xₙ} includes one sound component (e.g., a beep) recorded by the microphone, the procedure will reject H₀ with the stopping time t_{d}, at which the presence of the audio signal is declared. A false alarm is raised whenever the detection is declared before the change occurs, i.e., when t_{d}< [symbol] . If t_{d}≧ [symbol] , then (t_{d}− [symbol] ) is the detection delay, which represents the ranging accuracy.

Sequential change-point detection requires that the signal distribution for both noise and the sound component (e.g., beep) is known. This is difficult because the distribution of the audio signal frequently changes due to multipath distortions. Thus, rather than trying to estimate this distribution, the cumulative sum of difference to the averaged noise level is used. This allows first arriving signal detection without knowledge knowing the distribution of the first ABS. Suppose the MCD estimates the mean value μ of noise starting at time t₀ until tᵢ, which is the time that the MCD starts transmitting the sound component (e.g., beep). It is desirable to detect the first ABS as the signal that significantly deviates from the noise in the absence of the distribution of the first ABS. Therefore, the likelihood that the observed signal is from Xᵢ the sound component (e.g., beep) can be approximated as

l(X₁)=(Xᵢ−μ)

given that the recorded audio signal is stronger than the noise. The likelihood l(Xᵢ) shows a negative drift if the observed signal Xᵢ is smaller than the mean value of the noise, and a positive drift after the presence of the sound component (e.g., beep), i.e., Xᵢ stronger than noise. The stopping time for detecting the presence of the sound component (e.g., beep) is given by

t_{d}=inf(k|sₖ>h), satisfy sₘ>h, m=k, . . . , k+W

where h is the threshold, W is the robust window used to reduce the false alarm, and sₖ is the metric for the observed signal sequence {X₁, . . . , Xₖ}, which can be calculated recursively:

sₖ=max{sₖ₋₁+l(Xₖ),0}

where s₀=0.

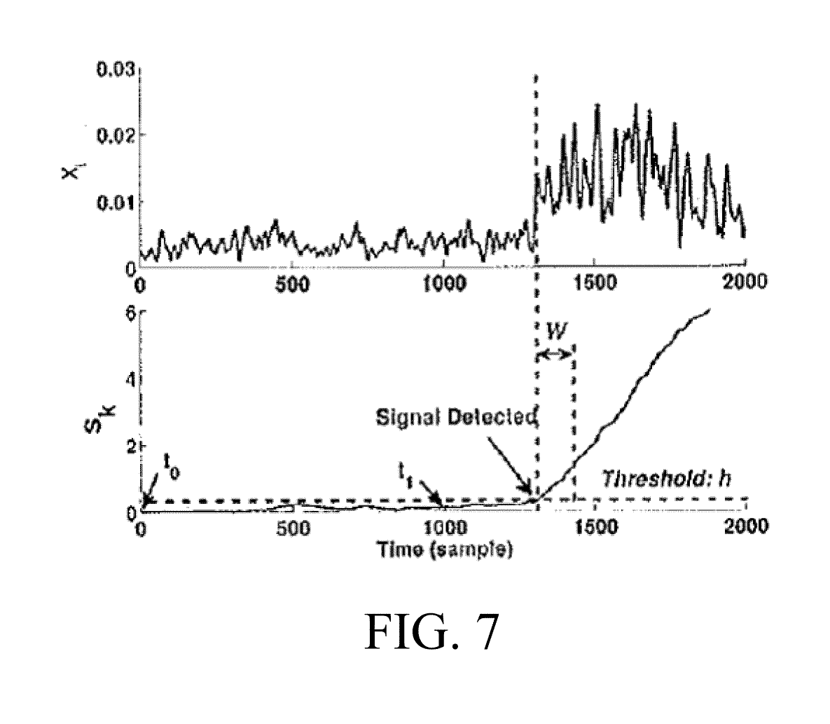

FIG. 7 shows an illustration of the first ABS detection in accordance with the above-described signal detection technique. The upper plot shows the observed signal energy along time series and the lower plot shows the cumulated sum of the observed signal.

In some scenarios, the threshold was set as the mean value sₖ plus three standard deviations sₖ when k belongs to t₀ to t₁ (i.e., 99.7% confidence level of noise). The window W (e.g., W=40) is used to filter out outliers in the cumulative sum sequence due to any sudden changes of the noise. At the same time point that the MCD starts to emit a sound component (e.g., a beep sound), the MCD starts to record received audio signals. Once the first ABS is detected, the window W is shifted to the approximate time point of the next sound component (e.g., a next beep) since the fixed interval between two adjacent sound components (e.g., beeps) is known.

Referring again to FIG. 6A, relative ranging is performed to obtain the time difference between signal arriving from two speakers, subsequent to completing step 608 (i.e., after the first and/or second ABS(s) is detected). In this regard, method 600 continues with steps 610-614. Given a constant sampling frequency and known speed of sound, the corresponding physical distance is easy to compute, as evident from the following discussion.

In step 610, the number of samples Sᵢⱼ is determined between the first sound component (e.g., beep) of the first ABS and the first sound component (e.g., beep) of the second ABS. Next in step 612, a time difference ΔTᵢⱼ is computed between the two speakers (e.g., a front-left speaker i and a front-right speaker j) using the number of samples Sᵢⱼ and a sampling frequency f. The computation of step 612 can be defined by the following mathematical equation (2).

ΔTᵢⱼ=Sᵢⱼ/f (2)

Thereafter in step 614, a physical distance Δdᵢⱼ is computed between the MCD and the two speakers using the time difference ΔTᵢⱼ and the speed of sound c. The computation performed in step 614 can be defined by the following mathematical equation (3).

Δdᵢⱼ=c·ΔTᵢⱼ (3)

After completing the relative ranging operations of steps 610-614, a determination is made in step 616 as to whether the stereo system of the vehicle is a two channel stereo system. If the stereo system is a two channel stereo system [616:YES], then method 600 continues with steps 618-622 in which location classification operations are performed to determine which one of two speakers (e.g., a front-left speaker or a front-right speaker) is closest to the MCD. In this regard, step 618 involves making a determination as to whether or not the physical distance Δdᵢⱼ is greater than a threshold value THₗᵣ. In some scenarios, the value of THₗᵣ is selected to be zero. Embodiments of the present invention are not limited in this regard. For example, the value of THₗᵣ can alternatively be set to −5 cm since drivers are often likely to place the MCD in a center console of the vehicle. If the physical distance Δdᵢⱼ is greater than the threshold value THₗᵣ [618:YES], then it is concluded that the speaker on the left-side (or driver-side) of the vehicle is closest to the MCD. In contrast, if the physical distance Δdᵢⱼ is less than the threshold value THₗᵣ, then it is concluded that the speaker on the right-side (or passenger-side) of the vehicle is closest to the MCD.

If the stereo system is not a two channel stereo system [616:NO] (or is a four channel stereo system), then method 600 continues with steps 624-636 of FIG. 6B in which additional relative ranging operations are performed as well as location classification operations. In this regard, step 624 involves repeating steps 606-614 using the ABSs corresponding to signals emitted from a second set of speakers (e.g., the left side speakers) and the ABSs corresponding to the signals emitted from a third set of speakers (e.g., the right side speakers).

Thereafter, a decision is made in step 626 as to whether the physical distance (Δd_{LS}+Δd_{RS})/2 is greater than a threshold value TH_{fb}, where Δd_{LS} represents the distance difference from two left speakers and Δd_{RS} represents the distance difference from two right speaker. If the physical distance (Δd_{LS}+Δd_{RS})/2 is greater than a threshold value TH_{fb} [626:YES], then method 600 continues with step 628 where it is concluded that the front speakers are closer to the MCD than the rear speakers. In this case, step 630 is performed to discriminate driver side and passenger side. Accordingly, steps 618-622 are performed in step 630 to determine whether the left or right side front speaker is closest to the MCD. Subsequently, step 636 is performed where method 600 ends or other processing is performed.

If the physical distance (Δd_{Ls}+Δd_{RS})/2 is less than a threshold value TH_{fb} [626:NO], then method 600 continues with step 632 where it is concluded that the rear speakers are closer to the MCD than the front speakers. In this case, step 634 is performed to discriminate driver side and passenger side. Accordingly, steps 602-622 are repeated using the ABSs corresponding to signals emitted from a fourth set of speakers (e.g., the rear speakers). Subsequently, step 636 is performed where method 600 ends or other processing is performed.

### Exemplary Implementations of the Present Invention

Exemplary implementations of the present invention will be described below in relation two different types of mobile phones. The present invention is not limited by the particularities of the exemplary implementations. The following discussion is simply provided to assist a reader in understanding the present invention, and the advantages of the same.

As noted above, the MCD can include, but is not limited to, a mobile phone such as an ADP2 phone (“phone I”) and/or an iPhone 3G (“phone II”). Each phone I and II has a Bluetooth radio and supports 16-bit 44.1 kHz sampling from a microphone thereof. Phone I is equipped with 192 MB RAM and an 528 MHz MSM7200A processor. Phone II is equipped with a 256 MB RAM and a 600 MHz ARM Cortex A8 processor.

As also noted above, the vehicle can include, but is not limited to, a car such as a Honda Civic (“car I”) and/or an Acura Sedan (“car II”). Cars I and II have two front speakers located at two front door's lower front sides, and two rear speakers in a rear deck. The interior dimensions of car I are about 175 cm (width) by 183 cm (length). The interior dimensions of car II are about 185 cm (width) by 203 cm (length).

Since both cars I and II are equipped with the two channel stereo system, the four channel sound system can be simulated by using a fader system of an audio unit thereof. Specifically, a two channel beep sound can be encoded and emitted first from the front speakers while the rear speakers are muted. Thereafter, the two channel beep sound can be emitted from the rear speakers while the front speakers are muted. The two channel beep sound can be pre-generated and stored in an audio file. The two channel beep sound can be pre-generated by: creating a beep defined by uniformly distributed white noise; bandpass filtering the uniformly distributed white noise to the 16-18 kHz band for phone 1 and 18-20 kHz band for phone II; and replicating the beep four times with a fixed interval of 5,000 samples between each beep so as to avoid interference from two adjacent beeps. The four beep sequence can then be stored first in the left channel of the audio file and after a 10,000 sample gap repeated on the right channel of the audio file.

Experiments were conducted in accordance with three scenarios. The three scenarios are described below.

Scenario 1: Phone I, Car I

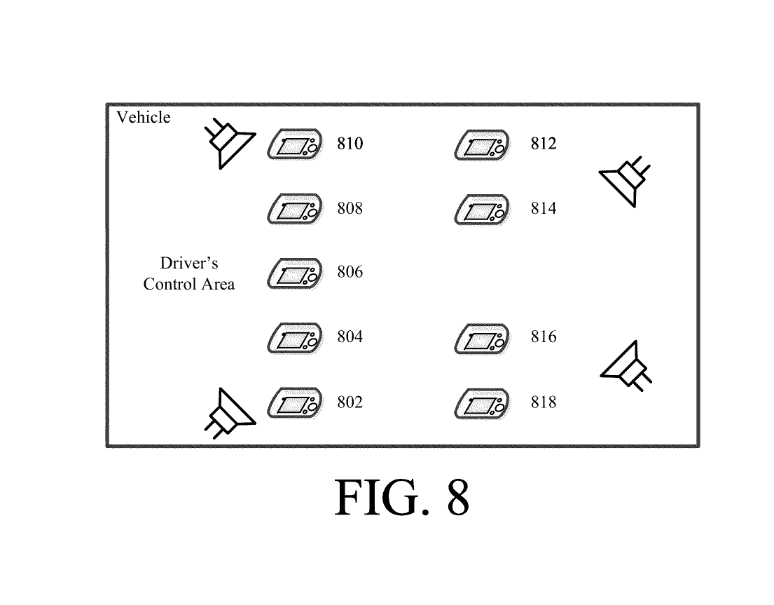

In this scenario, phone I is used while car I is stationary. Background noises stem from conversation and an idling engine. As illustrated in FIG. 8, phone I can be placed in a plurality of different locations 802-818 within car I. These locations include, but are not limited to: a driver's side left panel pocket (802); a driver's right pant pocket (804); a cup holder on a center console (806); a front passenger's left pant pocket (808); a front passenger's right pant pocket (810); right rear passenger's right pant pocket (812); right rear passenger's left pant pocket (814); a left rear passenger's right pant pocket (816); and a left rear passenger's left pant pocket (818). When phone I is in the five front positions 802-810, the following two cases are analyzed: the driver and front passenger are in the car; and the driver, front passenger, and left rear passenger are in the car. When phone I is located in the rear positions 812-818, the following case is analyzed: the driver and all three passengers are in the car.

Scenario 2: Phone II, Car II

In this scenario, phone II is used while car II is stationary. Background noise is not present. Three occupy variant cases are studied: only the driver is in the car II; driver and co-driver are in the car; driver, co-driver and a passenger are in the car II. Two positions are tested in the first occupy variant case: driver door handle; and cup holder. Four positions are tested in the second occupy variant case: driver door handle; cup holder; co-driver's left pant pocket; and co-driver's door handle. Six positions are tested in the third occupy variant case: driver door handle; cup holder; co-driver's left pant pocket; co-driver's door handle; passenger's left seat; and passenger's rear left seat door handle.

Scenario 3: Highway Driving

In this scenario, phone I is deployed in car I. Background noise is not present at first, but then becomes present due to both front windows being opened. The car is driving on the highway at the speed of 60 MPH with music playing therein. The four positions are tested in this scenario: driver's left pant pocket; cup holder; co-driver holding the phone; and co-driver's right pant pocket.

For experimentation purposes, certain metrics are defined. Classification Accuracy (“accuracy”) as used herein refers to the percentage of the trials that were correctly classified as driver phone use or correctly classified as passenger phone use. Detection Rate (“DR”) as used herein refers to the percentage of trials within the driver control area that are classified as driver phone use. False Positive Rate (“FPR”) as used herein refers to the percentage of passenger phone use that is classified as driver phone use. Measurement Error (“ME”) as used herein refers to the difference between the measured distance difference (i.e., Δdᵢⱼ) and the true distance difference. The ME metric directly evaluates the performance of relative ranging in the ARR algorithm.

Driver Vs. Passenger Phone Use

Values for DR, FPR and Accuracy are shown in Table 1 when determining driver phone use using the two channel stereo system.

TABLE 1

| | | | | |
|---|---|---|---|---|
| Scenario | Threshold | DR | FPR | Accuracy |

Two Channel Stereo System, Phone At Front Seats

| | | | | |
|---|---|---|---|---|
| 1 | Un-calibrated | 99% | 4% | 97.3% |
| | Calibrated | 100% | 4% | 98% |
| 2 | Un-calibrated | 94% | 3% | 95% |
| | Calibrated | 98% | 7% | 96% |
| 3 | Un-calibrated | 95% | 24% | 87% |
| | Calibrated | 91% | 5% | 92% |

Four Channel Stereo System, Phone All Seats

| | | | | |
|---|---|---|---|---|
| 1 | Un-calibrated | 94% | 4% | 97.3% |
| | Calibrated | 100% | 4% | 98% |
| 2 | Un-calibrated | 84% | 16% | 84% |
| | Calibrated | 91% | 3% | 94% |

Note that since the two channel system cannot distinguish the driver-side passenger seat from the driver seat, only front phone positions are tested. To test the robustness of the system in relation to two different types of cars, an un-calibrated system (which uses a default threshold THₗᵣ) and a calibrated system (which uses a threshold value THₗᵣ selected based on the car's dimensions and speaker layout) is distinguished. The threshold value THₗᵣ in the un-calibrated system is set to −5 cm for both cars I and II. The threshold value THₗᵣ in the calibrated system is set to −7 cm for car I and −2 cm for car II.

Two Channel Stereo System

From TABLE 1, the important observation in scenario 3 is that the present system can achieve close to 100% DR (with a 4% FPR), which results in about 98% accuracy, suggesting that the present system is highly effective in detecting driver phone use while driving. DR for both un-calibrated and calibrated systems is more than 90% while FPR is around 5% except for car II setting. This indicates the effectiveness of the detection operations of the present system. The high FPR of car II setting can be reached through calibration of the threshold THₗᵣ. Although DR is reduced when reducing FPR for car II, the overall detection accuracy is improved. These results show that the present system is robust to different types of vehicles and can provide reasonable accuracy without calibration.

Recall that in this experiment, only front phone positions were considered since the two channel stereo system can only distinguish between driver-side and passenger-side positions. With phone positions on the back seat, particularly the driver-side rear passenger seat, detection accuracy will be degraded, although DR remains the same. Real life accuracy will depend on where drivers place their phones in the vehicle and how often passengers use their phone from other seats. Statistics show that the two front seats are the most frequency occupied seats. In particular, according to an FARS 2009 database, 83.5% of vehicles are only occupied by a driver and possibly one front seat passenger, whereas only about 16.5% of trips occur with back seat passengers. More specifically, only 8.7% of the trips include a passenger sitting behind the driver seat—the situation that would increase the FPR.

If the phone locations are weighed by these probabilities, the FPR rate only increases to about 20% even with the two channel system. The overall accuracy of detecting driver phone use remains about 90% for all three scenarios. Accordingly, the present invention successfully produces high detection accuracy even with systems limited to a two channel stereo.

Four Channel Stereo System

The experimental results of using a four channel stereo system employing un-calibrated threshold values and calibrated threshold values are also shown in TABLE 1. The un-calibrated threshold value TH_{fb} (i.e., the threshold for the front and back speaker discrimination) is set to 0 cm for cars I and II and the un-calibrated threshold value THₗᵣ (i.e., the threshold for the left and right speaker discrimination) is set to −5 cm for cars I and II. For car I, the calibrated threshold value TH_{fb} (i.e., the threshold for the front and back speaker discrimination) is set to 15 cm and the un-calibrated threshold value THₗᵣ (i.e., the threshold for the left and right speaker discrimination) is set to −5 cm. For car II, the calibrated threshold value TH_{fb} (i.e., the threshold for the front and back speaker discrimination) is set to −24 cm and the un-calibrated threshold value THₗᵣ (i.e., the threshold for the left and right speaker discrimination) is set to −2 cm. With the calibrated thresholds, DR is above 90% and the accuracy is around 95% for both settings. This shows that the four channel system can improve the detection performance, compared to that of the two-channel stereo system. In addition, the performance under un-calibrated thresholds is similar to that under calibrated thresholds for car I setting. However, it is much worse than that of calibrated thresholds for car II settings. This suggests that calibration is more important for distinguishing the rear area, because the seat locations very more in the front-back dimensions across cars (and due to manual seat adjustments).

### Position Accuracy and Seat Classification

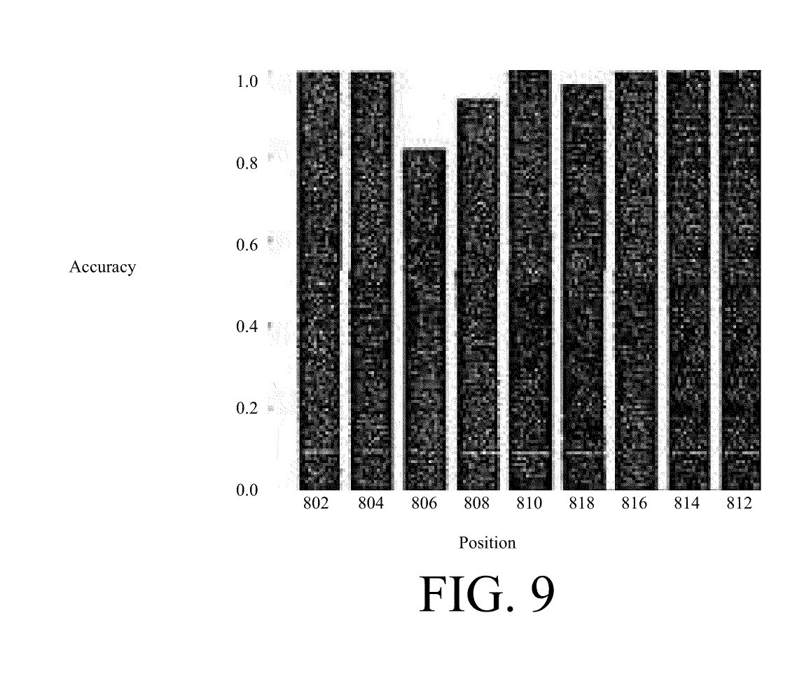

The present algorithm accuracy is now evaluates at different positions and seats within the vehicle. FIG. 9 shows the accuracy of detecting driver phone use for different positions in car I setting under calibrated thresholds. An observation is made that all the trials can be correctly classified at the positions 802, 804, 810, 816, 814, 812 as denoted in FIG. 8, whereas the detection accuracy decreases to 93% for position 808 (i.e., co-driver's left pocket) and 82% for position 806 (i.e., cup holder). Additionally, the doors' handle position in the car II setting was tested. This test found that the accuracy for driver's door handle is 99%, and 97% for the co-driver's door handle. These results provide a better understanding of the ARR algorithms performance at different positions in a vehicle.

Seat classification results are also derived. TABLE 2 shows the accuracy when determining a phone at each seat under un-calibrated and calibrated thresholds using a four channel stereo system.

TABLE 2

| | | | |
|---|---|---|---|
| Driver | Co-Driver | Rear Left | Rear Right |

Scenario 1: Phone I, Car I

| | | | | |
|---|---|---|---|---|
| Un-Calibrated | 95% | 95% | 99% | 99% |
| Calibrated | 96% | 95% | 99% | 99% |

Scenario 2: Phone II, Car II

| | | | | |
|---|---|---|---|---|
| Un-Calibrated | 84% | 88% | 94% | N/A |
| Calibrated | 94% | 94% | 98% | N/A |

As can be seen from TABLE 2, the accuracy of the back seats is higher than that of the front seats. Notably, it is hard to classify the cup holder and co-driver's left position since they are physically close to each other.

Left vs. Right Classification

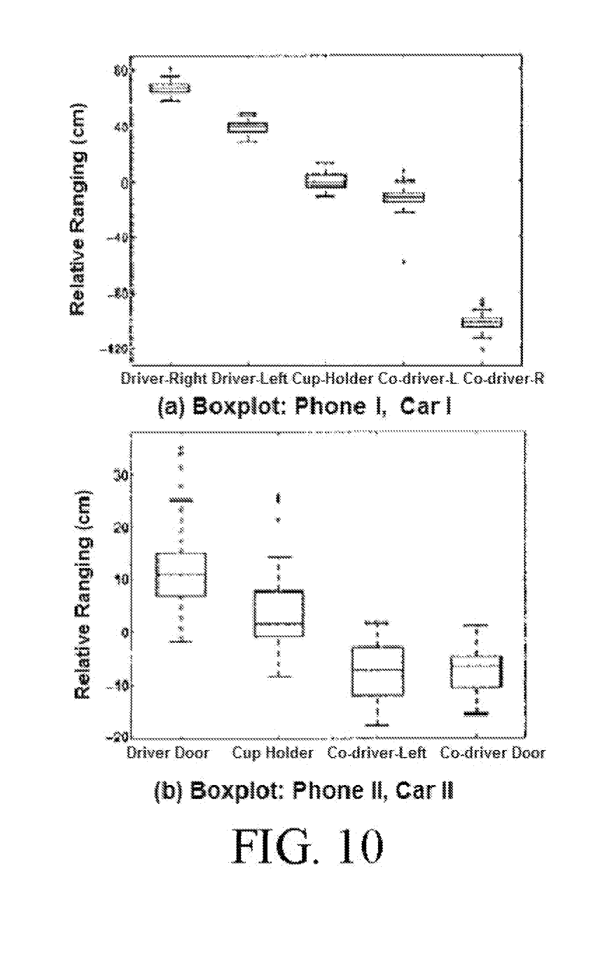

FIG. 10 illustrates a boxplot of the measured Δdₗᵣ at different tested positions. On each box, the central mark is the median, the edges of the box are the 25^{th} and 75^{th} percentiles, the whiskers extend to the most extreme data points. Note that the scale of the y-axis in FIG. 10(a) is different from that of FIG. 10(b). The boxes are clearly separated from each other showing that: different relative ranging values were obtained at different positions; and the different positions can be perfectly identified by examining the measured values from relative ranging except the cup holder and co-driver's left positions for cars I and II settings. By comparing FIG. 10(a) and FIG. 10(b), it is evident that the relative ranging results of driver's and co-driver's doors are much smaller than that of the driver's left and co-driver's right pockets, which is in conflict with the ground truth. This is mainly because the shortest path that the signal travels to reach the phone is significantly longer than the actual distance between the phone and the nearby speaker when putting the phone at door's handle since there is no direct path between the phone and speaker, i.e., the nearby speaker is facing the opposite side of the phone.

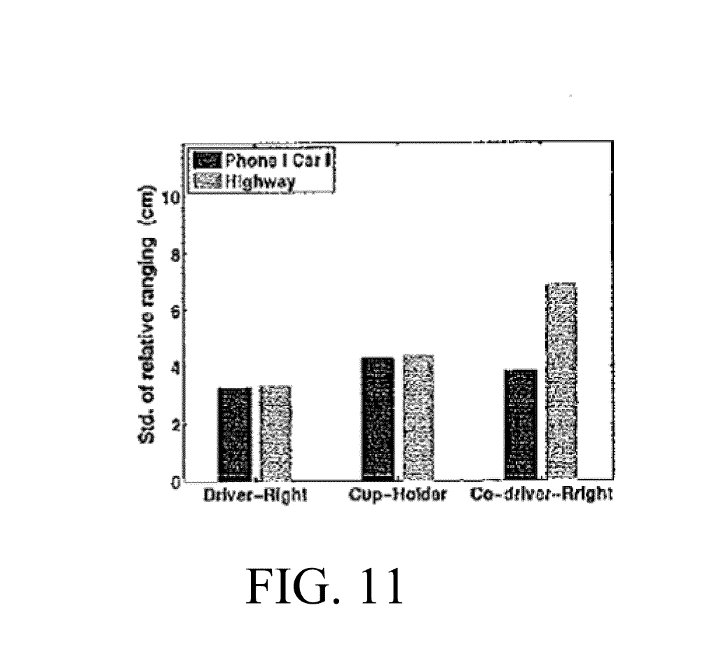

To compare the stability of the ranging results under the Highway driving scenario to the stationary scenario, a graph was created plotting the standard deviation of the relative ranging results at different positions. This graph is shown in FIG. 11. As evident from FIG. 11, the present algorithm produces similar stability of detection when the vehicle is driving on a highway to that when the vehicle is parked. Notably, at the co-driver's right position, the relative ranging results of the highway driving scenario still achieves 7 cm of standard deviation, although it is not as stable as that of the scenario 1 setting due to the movement of the co-driver's body caused by a moving vehicle.

Front vs. Back Seat Classification

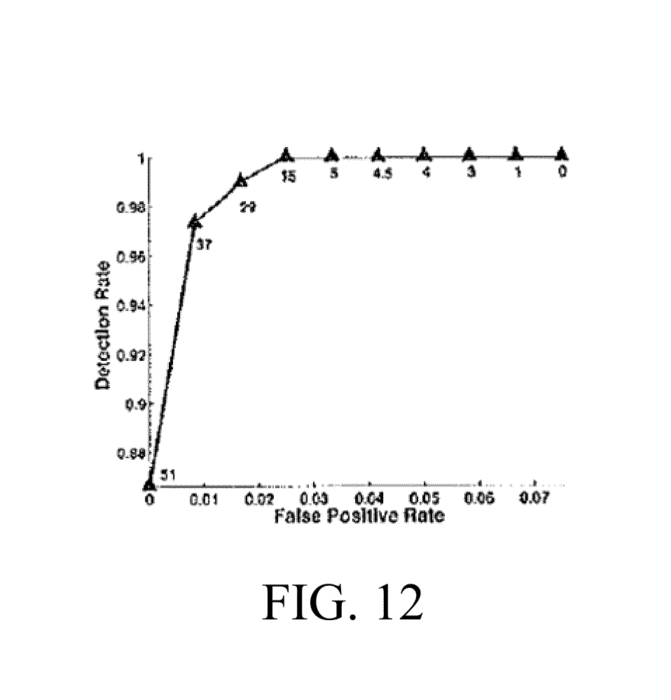

In front and back classification, the detection rate is defined as the percentage of the trials on front seats that are classified as front seats. FPR is defined as the percentage of back seat trials that are classified as front seats. FIG. 12 plots the ROC of detecting the phone at front seats in the car I setting. The present algorithm achieved over a 98% DR with less than a 2% FPR. These results demonstrate that it is relatively easier to classify front and back seats than that of left and right seats since the distance between the front and back seats is relatively larger. The present algorithm can perfectly classify front seats and back seats with only a few exceptions.

### Relative Ranging Results

The ME of a relative ranging mechanism is now presented. Also, the ME is compared to previous work using a chirp signal and correlation signal detection method with a multipath mitigation mechanism.

### Correlation Based Method

To be resistant to ambient noise, the correlation method uses the chirp signal as a beep sound. To perform signal detection, this method correlates the chirp sound with the recorded signal using L₂-norm cross-correlation, and picks the time point when the correlation value is the maximum as the time signal detected. To mitigate the multipath, instead of using the maximum correlation value, the earliest sharp peak in the correlation values is suggested as the signal detected time. This approach is referred to as the correlation method with mitigation mechanism.

Strategy for Comparison

To investigate the effect of multipath in an enclosed in-vehicle environment and the resistance of beep signals to background noise, experiments were designed by putting phone I in car I at three different positions with Line Of Sight (“LOS”) to two front speakers. At each position, MEs were calculated to obtain a statistical result. To evaluate multipath effects, the TDOA values were measured for the present method and the correlation method with mitigation mechanism. To test the robustness under background noise, music was played in the vehicle at different sound pressure levels, which are 60 dB and 80 dB, representing moderate noise (e.g., people talking in the vehicle) and heavy noise (e.g., traffic on a busy road), respectively. The chirp sound used for the correlation method is a 50 millisecond length of 2-6 kHz linear chirp signal at 80 dB SPL.

Impact of Multipath

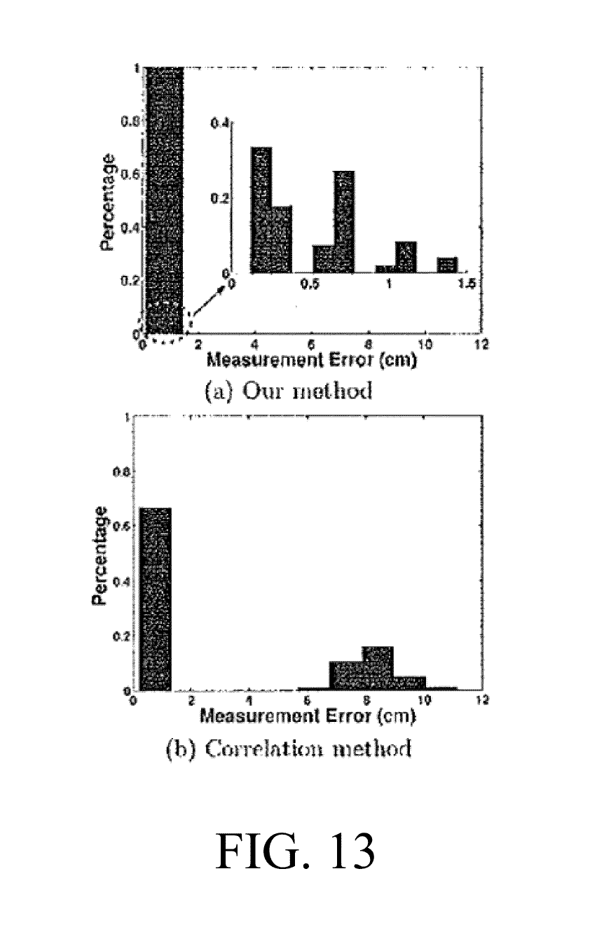

FIG. 13 shows a histogram of ME in a vehicle for both the present method and the correlation method with multipath mitigation mechanism. From FIG. 13, it can be observed that all MEs are within 2 cm, whereas more than 30% of the MEs of the correlation method are larger than 2 cm. Specifically, by examining the zoomed in histogram of FIG. 13(a), it becomes evident that the present method has most of the cases with MEs within 1 cm (i.e., one sample), whereas about 30% cases at around 8 cm (i.e., 10 samples) for the correlation method. The results show that the present method out performs the correlation method in mitigating MEs in an in-vehicle environment since the present signal detection method detects the first arriving signal, not affected by the subsequent arriving signal through different paths.

Impact of Background Noise

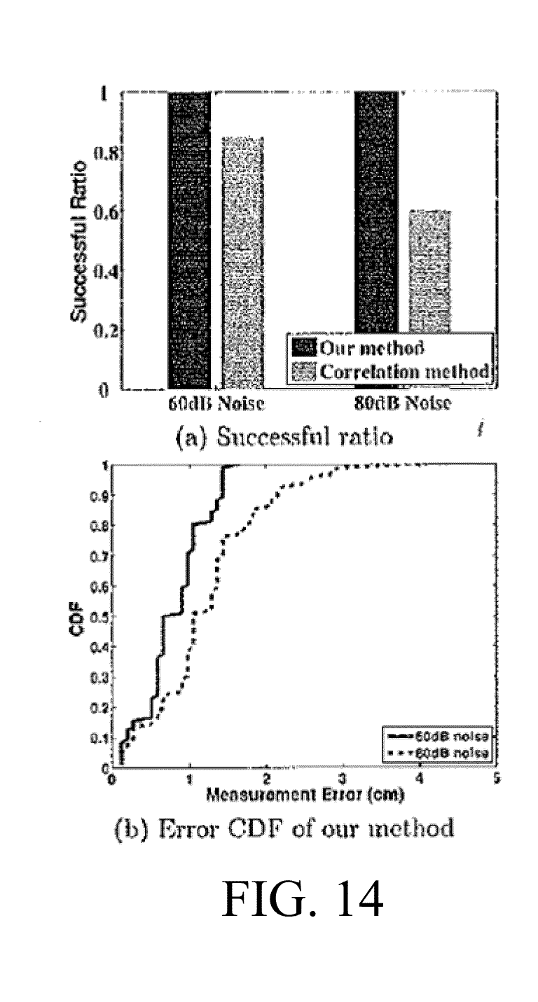

FIG. 14 comprises graphs that are useful for analyzing the impact of background noise. FIG. 14(a) illustrates the comparison of successful ration defines as the percentage of MEs within 10 cm for two methods. The present method successfully achieves within 10 cm ME for all the trials under both moderate and heavy noises, whereas the correlation method mitigation scheme achieves 85% for moderate noise and 60% for heavy noise over all the trials, respectively. FIG. 14(b) shows the ME CDF of the present method. The ME of the present method is only 0.66 cm under moderate noise and 1.05 cm under heavy noise. Both methods were also tested in a room environment (with people chatting at the background) using computer speakers, and found that both methods exhibit comparable performance.

In view of the forgoing, a driver mobile phone use detection system has been provides that requires minimal hardware and/or software medications on MCDs. The present system achieves this by leveraging the existing infrastructure of speakers for ranging via SRCs. The present system detects driver phone use by estimating the range between the phone and speakers. To estimate range, an ARR technique is employed in which the MCD plays and records a specially designed acoustic signal through a vehicle's speakers. The acoustic signal is unobtrusive as well as robust to background noise when driving. The present system achieves high accuracy under heavy multipath in-vehicle environments by using sequential change-point detection to identify the first arriving signal.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. A method for determining a location of a device in a space in which a plurality of external speakers are disposed, comprising:
receiving, by a single microphone of the device, a combined audio signal defined by a discrete audio signal output from a plurality of external speakers;
analyzing, by the device, the combined audio signal to determine the location of the device within the space.

2. The method according to claim 1, wherein the analyzing step comprises:
detecting an arriving time of a sound component of the discrete audio signal output from a first speaker of the plurality of external speakers and an arriving time of a sound component of the discrete audio signal output from a second speaker of the plurality of external speakers;
determining, by the device, a first relative time difference between the discrete audio signals arriving from the first and second speakers based on the arriving times which were previously detected; and
using this information to determine the location of the device within the space.

3. The method according to claim 1, wherein the audio signal is sequentially output from a plurality of external speakers in a pre-assigned order.

4. The method according to claim 1, wherein the discrete audio signal uses a frequency greater than frequencies within an audible frequency range for humans.

5. The method according to claim 1, further comprising:
communicating the discrete audio signal from the device to an external audio unit disposed within the space via a short range communication; and
causing the discrete audio signal to be output from the plurality of external speakers.

6. The method according to claim 2, further comprising:
determining a first number of samples between the sound component of the discrete audio signal output from the first speaker and the sound component of the discrete audio signal output from the second speaker; and
computing the first relative time difference using the first number of samples and a sampling frequency.

7. The method according to claim 6, further comprising computing a first physical distance between the device and two first speakers using the first relative time difference and speed of sound, where the two first speakers comprise the first and second speakers.

8. The method according to claim 7, further comprising:
comparing the first physical distance to a threshold value;
wherein the location of the device is determined based on results of the comparing.

9. The method according to claim 6, wherein the first relative time difference indicates that the device is located within a driver-side portion of the space of a vehicle's interior or a passenger-side portion of the space of the vehicle's interior.

10. The method according to claim 9, wherein the first speaker comprises a front-left speaker of a vehicle and the second speaker comprises a front-right speaker of the vehicle.

11. The method according to claim 7, further comprising:
determining a second number of samples between the sound component of the discrete audio signal output from a third speaker of the plurality of external speakers and the sound component of the discrete audio signal output from a fourth speaker of the plurality of external speakers;
computing a second relative time difference between the discrete audio signals arriving from the third and fourth speakers using the second number of samples and a sampling frequency; and
determining a second physical distance between the device and two second speakers using the second relative time difference and the speed of sound, where the two second speakers comprise the third and fourth speakers.

12. The method according to claim 11, further comprising:
comparing an average of the first and second physical distances to a threshold value;
wherein the location of the device is determined based on results of the comparing.

13. The method according to claim 12, wherein the results of the comparing indicate that the device is located within a front portion of the space of a vehicle's interior or a rear portion of the space of the vehicle's interior.

14. The method according to claim 13, wherein the first speaker comprises a front-left speaker of a vehicle, the second speaker comprises a rear-left speaker of the vehicle, the third speaker comprises a front-right speaker of the vehicle, and the fourth speaker comprises a rear-right speaker of the vehicle.

15. The method according to claim 1, further comprising performing by the device at least one operation to reduce distractions of a driver of a vehicle based on the location of the device within the space.

16. A system, comprising:
a plurality of speakers disposed within a space; and
a device comprising:
a microphone configured to receive a combined audio signal defined by a discrete audio signal output from the plurality of external speakers; and
at least one electronic circuit coupled to the microphone and configured to analyze the combined audio signal to determine a location of the device within the space.

17. The system according to claim 16, wherein the combined audio signal is analyzed by:
detecting an arriving time of a sound component of the discrete audio signal output from a first speaker of the plurality of external speakers and an arriving time of a sound component of the discrete audio signal output from a second speaker of the plurality of external speakers;
determining, by the device, a first relative time difference between the discrete audio signals arriving from the first and second speakers based on the arriving times which were previously detected; and
using this information to determine the location of the device within the space.

18. The system according to claim 16, wherein the audio signal is sequentially output from a plurality of external speakers in a pre-assigned order.

19. The system according to claim 16, wherein the discrete audio signal uses a frequency greater than frequencies within an audible frequency range for humans.

20. The system according to claim 16, wherein the electronic circuit is further configured to:
communicate the discrete audio signal from the device to an external audio unit disposed within the space via a short range communication; and
cause the discrete audio signal to be output from the plurality of external speakers.

21. The system according to claim 16, wherein the electronic circuit is further configured to:
determine a first number of samples between the sound component of the discrete audio signal output from the first speaker and the sound component of the discrete audio signal output from the second speaker; and
compute the first relative time difference using the first number of samples and a sampling frequency.

22. The system according to claim 21, wherein the electronic circuit is further configured to compute a first physical distance between the device and two first speakers using the first relative time difference and speed of sound, where the two first speakers comprise the first and second speakers.

23. The system according to claim 22, wherein the electronic circuit is further configured to:
compare the first physical distance to a threshold value;
wherein the location of the device is determined based on results of the comparing.

24. The system according to claim 21, wherein the first relative time difference indicates that the device is located within a driver-side portion of the space of a vehicle's interior or a passenger-side portion of the space of the vehicle's interior.

25. The system according to claim 24, wherein the first speaker comprises a front-left speaker of a vehicle and the second speaker comprises a front-right speaker of the vehicle.

26. The system according to claim 22, wherein the electronic circuit is further configured to:
determine a second number of samples between the sound component of the discrete audio signal output from a third speaker of the plurality of external speakers and the sound component of the discrete audio signal output from a fourth speaker of the plurality of external speakers;
compute a second relative time difference between the discrete audio signals arriving from the third and fourth speakers using the second number of samples and a sampling frequency; and
determine a second physical distance between the device and two second speakers using the second relative time difference and the speed of sound, where the two second speakers comprise the third and fourth speakers.

27. The system according to claim 26, wherein the electronic circuit is further configured to:
compare an average of the first and second physical distances to a threshold value;
wherein the location of the device is determined based on results of the comparing.

28. The system according to claim 27, wherein the results of the comparing indicate that the device is located within a front portion of the space of a vehicle's interior or a rear portion of the space of the vehicle's interior.

29. The system according to claim 28, wherein the first speaker comprises a front-left speaker of a vehicle, the second speaker comprises a rear-left speaker of the vehicle, the third speaker comprises a front-right speaker of the vehicle, and the fourth speaker comprises a rear-right speaker of the vehicle.

30. The system according to claim 16, wherein the electronic circuit is further configured to perform at least one operation to reduce distractions of a driver of a vehicle based on the location of the device within the space.
